(19) United States
(12) Patent Application Publication
(10) Pub. No.: US 2025/0237286 A1
(43) Pub. Date: Jul. 24, 2025

(54) FREQUENCY-SENSITIVE SHOCK ABSORBER AND VALVE ASSEMBLY EMPLOYED THERETO

(71) Applicant: HL Mando Corporation, Pyeongtaek-si (KR)

(72) Inventor: Sangyeon CHO, Pyeongtaek-si (KR)

(21) Appl. No.: 18/737,838

(22) Filed: Jun. 7, 2024

(30) Foreign Application Priority Data
Jan. 18, 2024 (KR) 10-2024-0008087

(51) Int. Cl. F16F 9/504; F16F 9/19; F16F 9/348; F16K 31/383

(52) U.S. Cl. CPC F16F 9/504; F16F 9/19; F16F 9/348; F16K 31/383; F16F 2222/12; F16F 2224/0208; F16F 2224/025; F16F 2228/04; F16F 2228/066; F16F 2230/18

(57) ABSTRACT

The present disclosure provides a frequency-sensitive shock absorber capable of implementing target performance of damping force by preventing a valve portion formed of a rubber material or a synthetic resin material constituting a pilot valve of a valve assembly from peeling in a high-pressure and high-temperature environment and securing a flow path, and a valve assembly employed therein. An upper pilot valve and a lower pilot valve each include a base portion in the form of a metal plate and a valve portion integrally molded with the base portion as an elastic material passes through a molded hole formed in a penetrating manner in the base portion, and elastically deformed vertically.

### CROSS-REFERENCE TO RELATED APPLICATIONS

This application claims benefit and priority to Korean Patent Application No. 10-2024-0008087, filed on Jan. 18, 2024, with the Korean Intellectual Property Office, the disclosure of which is incorporated herein in its entirety by reference.

### TECHNICAL FIELD

The present disclosure relates to a frequency-sensitive shock absorber and a valve assembly employed therein, and more particularly, to a frequency-sensitive shock absorber a frequency-sensitive shock absorber capable of implementing target performance of damping force by preventing a valve portion formed of a rubber material constituting a pilot valve of a valve assembly from peeling in a high-pressure and high-temperature environment and securing a flow path, and a valve assembly employed therein.

### BACKGROUND

Generally, vehicles are equipped with a shock absorbing device to improve ride comfort by cushion the shock or vibrations applied to the axle from the road surface while driving, and a shock absorber is used as one of the shock absorbing devices.

The shock absorber operates according to the vibrations of a vehicle according to a road surface condition, and here, damping force generated in the shock absorber varies depending on an operating speed of the shock absorber, that is, depending on whether the operating speed is fast or slow.

Since the ride comfort and driving stability of a vehicle may be controlled depending on how the damping force characteristics generated by the shock absorber are adjusted, it is very important to control the damping force characteristics of the shock absorber when designing a vehicle.

FIG. 1 is a cross-sectional view illustrating an example of a frequency-sensitive shock absorber according to the related art, FIG. 2 is a cross-sectional view illustrating an example of a valve assembly employed in a frequency-sensitive shock absorber according to the related art, and FIG. 3 is an exploded perspective view of the valve assembly of FIG. 2.

A frequency-sensitive shock absorber 1 according to the related art includes piston rods 21 and 22 that reciprocate inside a cylinder 10 and a piston valve 30 and a valve assembly 40 mounted on the piston rods 21 and 22.

The cylinder 10 may have a cylindrical shape forming a space therein, and the inside of the cylinder 10 is filled with a working fluid (oil).

Here, the inside of the cylinder 10 may be divided into a compression chamber 11 and a tension chamber 12 by the piston valve 30 to be described below.

The piston rods 21 and 22 include a main piston rod 21 provided on an upper side and on which the piston valve 30 is mounted and an auxiliary piston rod 22 coupled to a lower side of the main piston rod 21 and on which the valve assembly 40 is mounted.

The main piston rod 21 is provided on the upper side, one end thereof is located inside the cylinder 10, and the other end thereof extends to the outside of the cylinder 10 and is connected to a vehicle body side or a wheel side of a vehicle, and the piston valve 30 is mounted on one end of the main piston rod 21.

The auxiliary piston rod 22 is coupled to a lower side of the main piston rod 21.

One end of the auxiliary piston rod 22 is coupled to the main piston rod 21, and the valve assembly 40 is inserted into and mounted on the other end of the auxiliary piston rod 22.

The piston valve 30 is provided to reciprocate inside the cylinder 10 filled with working fluid together with the main piston rod 21 in a state in which the main piston rod 21 is penetratingly coupled to the piston valve 30.

In the piston valve 30, a plurality of compression flow paths 31 and tension flow paths 32 are formed to penetrate upwardly and downwardly so that the working fluid moves during compression and tension strokes.

The piston valve 30 reciprocates in a direction of the compression and tension strokes inside the cylinder 10 and generates damping force due to resistance of the working fluid.

The valve assembly 40 is mounted on the auxiliary piston rod 22 to be located below the piston valve 30.

The valve assembly 40 may serve to generate damping force that changes depending on the frequency during the tension stroke.

More specifically, the valve assembly 40 includes a housing 45 in which a pilot chamber 45a is formed in a lower portion, a main retainer 49 in which a main chamber 49a is formed in an upper portion, a lower pilot valve 47 disposed between the housing 45 and the main retainer 49 and partitioning the pilot chamber 45a and the main chamber 49a, and an upper pilot valve 44 disposed above the pilot chamber 45a and elastically deformed according to a change in pressure of the pilot chamber 45a.

In addition, the valve assembly 40 may further include an inlet disk 46 and a pilot disk 43.

The inlet disk 46 is interposed between the housing 45 and the lower pilot valve 47.

At least one slit 46a is formed in the inlet disk 46 to allow working fluid to flow into the pilot chamber 45a.

By adjusting the cross-sectional area and number of slits 46a, the amount of working fluid flowing into the pilot chamber 45a may be adjusted.

The pilot disk 43 is coupled to the auxiliary piston rod 22 and disposed in close contact with an upper portion of the upper pilot valve 44 and covers the upper portion of the upper pilot valve 44 to prevent inflow of working fluid from the upper portion of the upper pilot valve 44.

The pilot disk 43 includes a disk-S 43b in close contact with the upper portion of the upper pilot valve 44 to adjust a flow rate of the working fluid flowing out of the pilot chamber 45a and an auxiliary disk 43a in close contact with an upper portion of the disk-S 43b and elastically supporting the disk-S 43b.

The disk-S 43b has a flow groove G formed at a position corresponding to a first flow hole H1 of the upper pilot valve 44.

The auxiliary disk 43a may be provided as a disk having the same size as the disk-S 43b and impede the flow of the working fluid passing through the flow groove G. When pressure of the pilot chamber 45a increases, The auxiliary disk 43a may be elastically deformed to allow outflow of the working fluid.

In addition, the valve assembly 40 may further include at least one main disk 48 interposed between the lower pilot valve 47 and the main retainer 49.

In addition, the valve assembly 40 is mounted below a lower washer 41 with the spacer 42 in between, and a nut 51 is mounted below the valve assembly 40 and fastened to the auxiliary piston rod 22.

FIG. 4 is an enlarged view of the upper pilot valve in FIG. 3.

The upper pilot valve 44 includes an upper base portion 44a having an upper surface in close contact with the lower portion of the pilot disk 43 and an upper valve portion 44b downwardly protruding along an outer edge of the upper base portion 44a and in close contact with an inner circumferential surface of the housing 45 to form the pilot chamber 45a.

The upper base portion 44a may be formed of a metal disc shape, and the upper valve portion 44b may be formed of a rubber material or a synthetic resin material to be elastically deformable.

The upper base portion 44a and the upper valve portion 44b are attached with an adhesive or the like.

In addition, a plurality of first flow holes H1 may be formed in a penetrating manner radially in the upper base portion 44a. When pressure of the pilot chamber 45a continues to increase, the plurality of first flow holes H1 may allow the working fluid of the pilot chamber 45a to pass therethrough, thereby preventing an excessive increase in pressure.

Furthermore, the upper valve portion 44b may be elastically deformed depending on the pressure based on the amount of working fluid flowing into the pilot chamber 45a. For example, the upper valve portion 44b may be elastically deformed vertically.

FIG. 5 is an enlarged view of the lower pilot valve in FIG. 3.

The lower pilot valve 47 includes a lower base portion 47a having a bottom surface in close contact with the upper portion of the main retainer 49 and a lower valve portion 47b upwardly protruding along an outer edge of the lower base portion 47a and in close contact with an inner circumferential surface of the housing 45 to form the pilot chamber 45a.

The lower base portion 47a may be formed of a metal disc shape, and the lower valve portion 47b may be formed of a rubber material or synthetic resin material to be elastically deformable.

The lower base portion 47a and the lower valve portion 47b are attached with an adhesive or the like.

Accordingly, the lower valve portion 47b may be elastically deformed according to a pressure difference depending on the amount of working fluid flowing into the main chamber 49a and the pilot chamber 45a. For example, the lower valve portion 47b may be elastically deformed upwardly.

However, in the valve assembly 40 according to the related art, the upper base portion 44a and the upper valve portion 44b of the upper pilot valve 44 are attached with an adhesive, and there is a problem in that the upper valve portion 44b formed of rubber or synthetic resin material peels off from the upper base portion 44a in a high-pressure and high-temperature environment.

In addition, the lower base portion 47a and the lower valve portion 47b of the lower pilot valve 47 are attached with an adhesive, and there is a problem in that the lower valve portion 47b formed of rubber or synthetic resin material peels off from the lower base portion 47a in a high-pressure and high-temperature environment.

As a result, the target performance of damping force generated by the shock absorber cannot be implemented, and thus, it may be difficult to satisfy both ride comfort and driving stability.

### RELATED ART DOCUMENT

[Patent document]
(Patent Document 1) KR 10-2020-0142293 A

### SUMMARY

In view of the above, the present disclosure provides a frequency-sensitive shock absorber capable of implementing target performance of damping force by preventing a valve portion formed of a rubber material or a synthetic resin material constituting a pilot valve of a valve assembly from peeling in a high-pressure and high-temperature environment and securing a flow path, and a valve assembly employed therein.

In an aspect, a valve assembly employed in a shock absorber includes: a housing provided in a shape of a ring through which a piston rod that reciprocates inside a cylinder passes through a center, in which hollows are provided in the upper and lower surfaces in a communicatable manner to form a pilot chamber; a main retainer coupled to the piston rod and disposed in a lower portion of the housing, an upper portion of which is opened to form a main chamber; a lower pilot valve coupled to the piston rod to be interposed between the housing and the main retainer so that upper and lower portions thereof are in close contact with the housing and the main retainer, respectively, to divide and simultaneously form the pilot chamber and the main chamber; and an upper pilot valve coupled to the piston rod and disposed on top of the pilot chamber and provided to be elastically deformable according to a change in pressure of the pilot chamber, wherein the upper pilot valve and the lower pilot valve each includes a base portion in the form of a metal plate and a valve portion integrally molded with the base portion as an elastic material passes through a molded hole formed in a penetrating manner in the base portion, and elastically deformed vertically.

The upper pilot valve may include an upper base portion having a piston rod coupled to a center, formed in the shape of a metal disk, have a plurality of first flow holes formed in a penetrating manner radially, and have a plurality of first molded holes formed in a penetrating manner in a circumferential direction outside the first flow holes.

The upper pilot valve may include an upper valve portion in which an elastic material passes through the first molded hole, surround an outer portion of the first flow hole, which is an upper edge of the upper base portion, and protrude to a lower side of the upper base portion.

The elastic material may be a rubber material or an elastic synthetic resin material.

The lower pilot valve may have a piston rod coupled to a center, may be formed of a metal disc shape, and may have a plurality of second molded holes formed in a penetrating manner radially.

The lower pilot valve may include a lower valve portion in which an elastic material passes through the second molded hole, surround a lower edge of the lower base portion, and protrude to an upper side of the lower base portion.

The valve assembly may further include a guide disk formed of metal coupled to the piston rod to be located above the upper base portion.

A plurality of second flow holes may be formed in a penetrating manner radially in the guide disk.

The second flow holes may be formed in a number and positions corresponding to the first flow holes formed in the upper base of the upper pilot valve.

The guide disk may be maintained to be in metal-to-metal contact with a pilot disk located in an upper portion thereof and elastically deformed to allow working fluid to pass therethrough according to an increase in pressure of the pilot chamber during a tension stroke.

The pilot disk may include a disk-S in close contact with the upper portion of the guide disk and adjusting a flow rate of the working fluid flowing out of the pilot chamber and an auxiliary disk in close contact with an upper portion of the disk-S to elastically support the disk-S.

The disk-S may have a predetermined flow groove formed at a position corresponding to a first flow hole of the upper pilot valve and a second flow hole of the guide disk.

The auxiliary disk may be provided as a disk having the same size as the disk-S, impede flow of working fluid passing through the flow groove, and be elastically deformed to allow working fluid to flow out when pressure of the pilot chamber increases.

In another aspect, a frequency-sensitive shock absorber including a piston rod that reciprocates inside a cylinder filled with working fluid, a piston valve mounted on the piston rod and reciprocating inside the cylinder in compression and tension stroke directions to generate damping force based on resistance of the working fluid, and a valve assembly mounted on the piston rod to be disposed below the piston valve and generating damping force that changes depending on a frequency during the tension stroke, wherein the valve assembly includes: a housing provided in a shape of a ring through which a piston rod that reciprocates inside a cylinder passes through a center, in which hollows are provided in the upper and lower surfaces in a communicatable manner to form a pilot chamber; a main retainer coupled to the piston rod and disposed in a lower portion of the housing, an upper portion of which is opened to form a main chamber; a lower pilot valve coupled to the piston rod to be interposed between the housing and the main retainer so that upper and lower portions thereof are in close contact with the housing and the main retainer, respectively, to divide and simultaneously form the pilot chamber and the main chamber; and an upper pilot valve coupled to the piston rod and disposed on top of the pilot chamber and provided to be elastically deformable according to a change in pressure of the pilot chamber, wherein the upper pilot valve and the lower pilot valve each includes a base portion in the form of a metal plate and a valve portion integrally molded with the base portion as an elastic material passes through a molded hole formed in a penetrating manner in the base portion, and elastically deformed vertically.

The valve assembly may further include a disc-shaped metal guide disk coupled to the piston rod to be located above the upper pilot valve, and the guide disk may be maintained to be in metal-to-metal contact with a pilot disk located in an upper portion thereof and elastically deformed to allow working fluid to pass therethrough according to an increase in pressure of the pilot chamber during a tension stroke.

Details of other embodiments will be included in the “detailed description of preferred embodiments for carrying out the invention” and the accompanying “drawings”.

Advantages and/or features of the present disclosure, and a method for achieving the same will become apparent with reference to various embodiments described below as well as the accompanying drawings.

However, the present disclosure is not limited only to the configuration of each embodiment disclosed below, but may be implemented in various different forms, and only each embodiment disclosed in the present specification makes the disclosure of the present disclosure complete. Further, it should be understood that the present disclosure is provided to completely inform the scope of the present disclosure to those skilled in the art, and the present disclosure is only defined by the scope of each of the appended claims.

### Advantageous Effects

According to the solution to the aforementioned problems, the present disclosure has the following effects.

In the present disclosure, the upper pilot valve and the lower pilot valve each include a base portion in the form of a metal plate and a valve portion formed of an elastic material passing through a formation hole formed in the base portion so as to be integrally formed with the base portion and elastically deformed vertically, thereby preventing the valve portion formed of a rubber material constituting the pilot valve of the valve assembly from peeling in a high-pressure and high-temperature environment.

In addition, the present disclosure further includes a guide disk formed of metal in the form of a disk coupled to the piston rod to be located above the upper pilot valve, and the guide disk is maintained to be in metal-to metal contact with the pilot disk located thereabove and elastically deformed to allow working fluid to pass therethrough depending on an increase in pressure of the pilot chamber during a tension stroke, thereby preventing a flow path formed in the pilot disk from being blocked due to the rubber material or synthetic resin material forming the valve portion, thereby implementing the target performance of damping force.

In addition, the present disclosure has the effect of reducing manufacturing costs by utilizing the existing mass-produced parts as it is without changing a configuration thereof.

### BRIEF DESCRIPTION OF THE DRAWINGS

FIG. 1 is a cross-sectional view illustrating an example of a frequency-sensitive shock absorber according to the related art.

FIG. 2 is a cross-sectional view illustrating an example of a valve assembly employed in a frequency-sensitive shock absorber according to the related art.

FIG. 3 is an exploded perspective view illustrating a valve assembly of FIG. 2.

FIG. 4 is an enlarged view of an upper pilot valve in FIG. 3.

FIG. 5 is an enlarged view of a lower pilot valve in FIG. 3.

FIG. 6 is a perspective view illustrating a valve assembly employed in a frequency-sensitive shock absorber according to the present disclosure.

FIG. 7 is a cross-sectional view illustrating the valve assembly of FIG. 6.

FIG. 8 is an enlarged view of an upper pilot valve in the valve assembly of FIG. 6.

FIG. 9 is a view illustrating that the upper valve portion is integrally molded with an upper base portion of the upper pilot valve shown in FIG. 8.

FIG. 10 is a view illustrating the upper base portion of the upper pilot valve shown in FIG. 8.

FIG. 11 is a diagram illustrating a guide disk disposed between a pilot disk shown in FIG. 6 and the upper pilot valve.

FIG. 12 is an enlarged view of a lower pilot valve in the valve assembly of FIG. 6.

FIG. 13 is a view illustrating that a lower valve portion is integrally molded with a lower base portion of the lower pilot valve shown in FIG. 12.

FIG. 14 is a view illustrating the lower base portion of the lower pilot valve shown in FIG. 12.

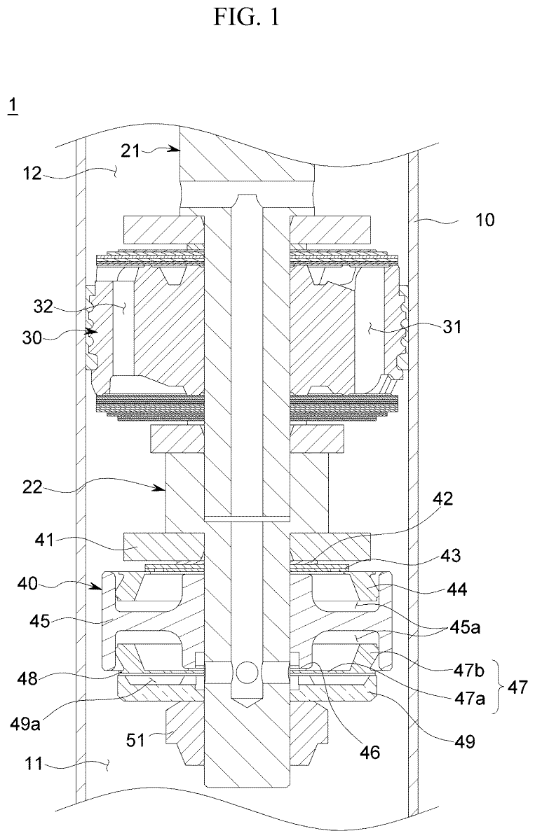

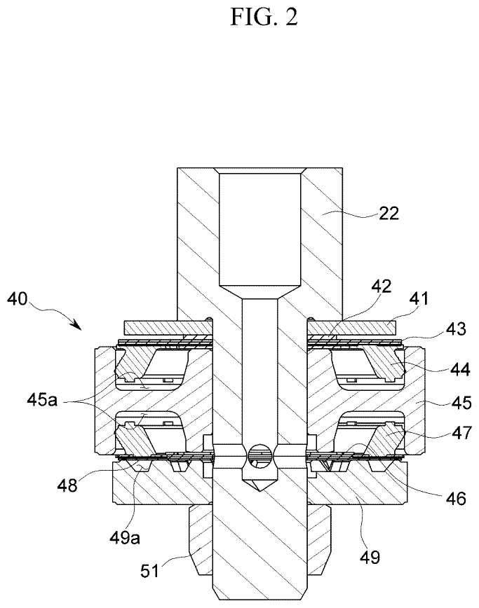

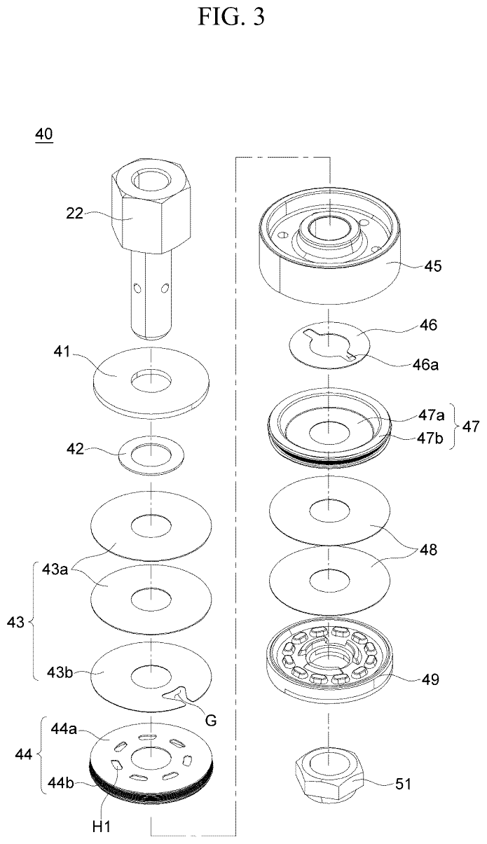

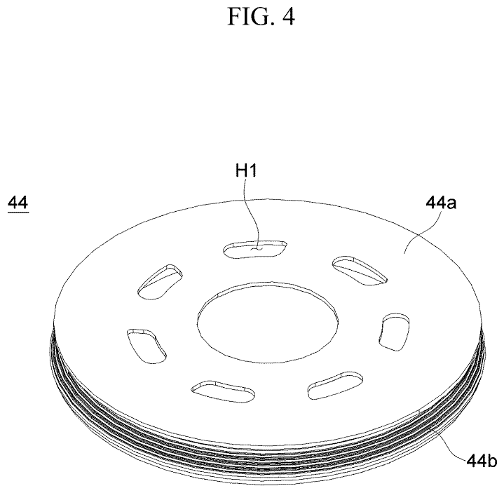

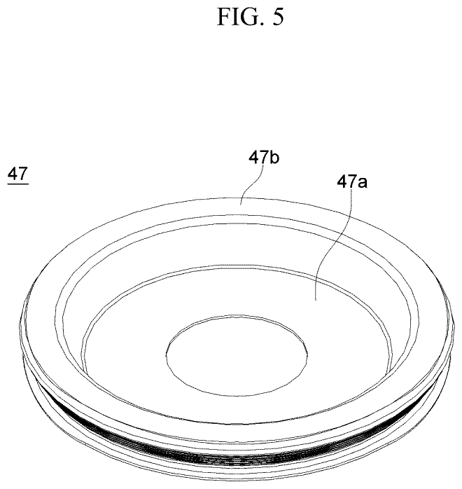

### DETAILED DESCRIPTION

Hereinafter, preferred embodiments of the frequency-sensitive shock absorber and the valve assembly employed therein according to the present disclosure will be described in detail based on the attached drawings. For reference, terms and words used in the present specification and claims to be described below should not be construed as limited to ordinary or dictionary terms, and should be construed in accordance with the technical idea of the present disclosure based on the principle that the inventors may properly define their own inventions in terms of terms in order to best explain the invention. Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

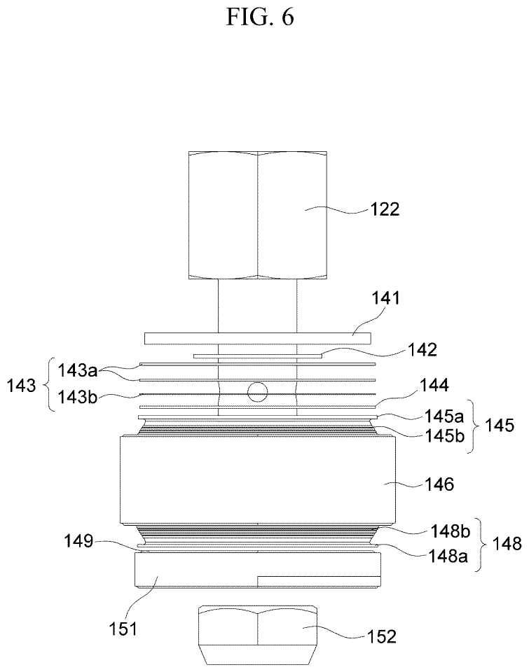

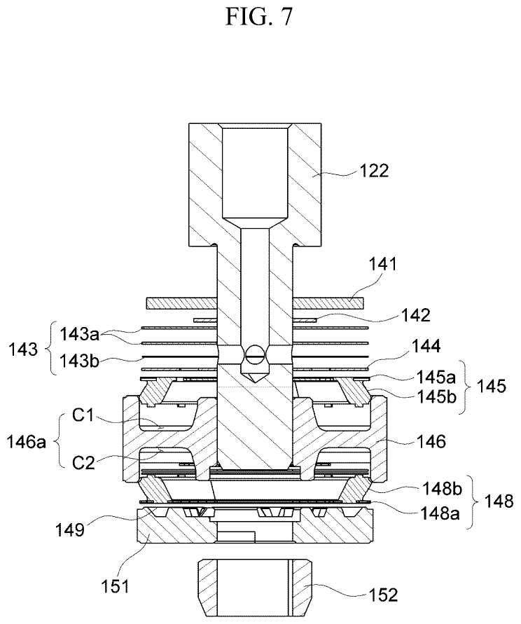

FIG. 6 is a perspective view illustrating a valve assembly employed in a frequency-sensitive shock absorber according to the present disclosure, and FIG. 7 is a cross-sectional view illustrating the valve assembly of FIG. 6.

The frequency-sensitive shock absorber according to the present disclosure includes a piston rod that reciprocates inside a cylinder and a piston valve and a valve assembly mounted on the piston rod.

The cylinder, the piston rod, and the piston valve are the same as the components disclosed in Korean Patent Publication No. 10-2020-0142293 of the present applicant, so detailed description thereof is omitted and only the valve assembly according to the present disclosure is described.

A valve assembly 140 according to the present disclosure serves to generate damping force that changes depending on the frequency during a tension stroke and includes a housing 146, a main retainer 151, a lower pilot valve 148, an upper pilot valve 145, and a guide disk 144.

The housing 146 is coupled to the auxiliary piston rod 122, and a pilot chamber 146a is formed inside the housing 146.

Specifically, the housing 146 includes the pilot chamber 146a provided in a ring shape with the auxiliary piston rod 122 penetrating through the center and having hollows provided on upper and lower surfaces in a communicating manner.

At this time, the pilot chamber 146a may be formed of an upper pilot chamber C1, a lower pilot chamber C2, and a communication hole (not shown). The lower pilot chamber C2 is formed between the housing 146 and the lower pilot valve 148 and communicates with an auxiliary connection flow path formed in the auxiliary piston rod 122. The upper pilot chamber C1 is formed between the housing 146 and the upper pilot valve 145 and is provided to communicate with the lower pilot chamber 148 through a plurality of communication holes (not shown) provided radially.

The main retainer 151 is coupled to the auxiliary piston rod 122 and is disposed below the housing 146, and the upper portion is opened to form a main chamber (not shown).

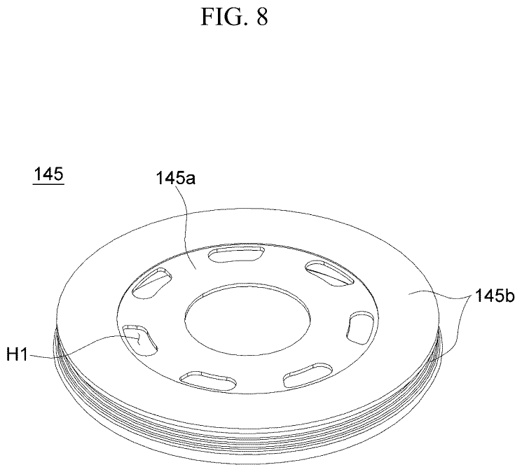

The upper pilot valve 145 is disposed above the upper pilot chamber C1 and is provided to be elastically deformable according to a change in pressure in the upper pilot chamber C1, and a description thereof is given below based on FIGS. 8 to 10.

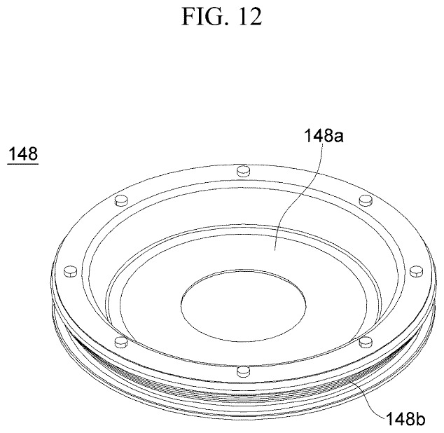

The lower pilot valve 148 is disposed between the housing 146 and the main retainer 151 to partition the pilot chamber 146a and the main chamber, and a description thereof is given below based on FIGS. 12 to 14.

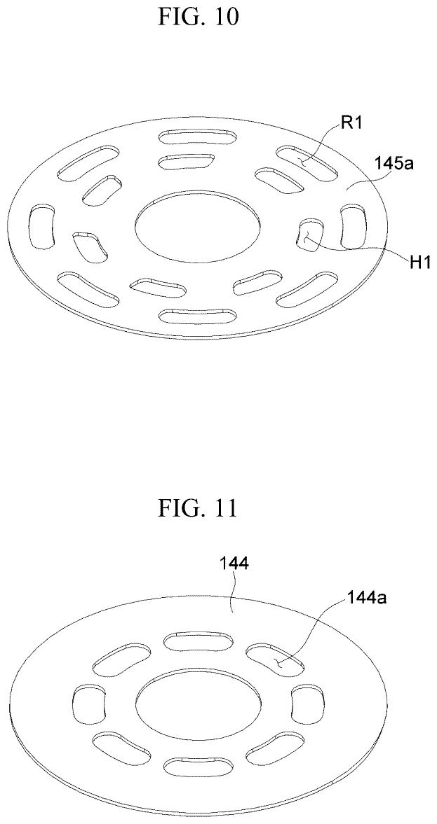

The guide disk 144 is disposed above the upper pilot valve 145, and a description thereof is given below based on FIG. 11.

Meanwhile, the valve assembly 140 may further include an inlet disk 147 and a pilot disk 143.

The inlet disk 147 is interposed between the housing 146 and the lower pilot valve 148.

At least one slit is formed in the inlet disk 147 to allow working fluid to flow into the pilot chamber 146a.

This inlet disk 147 may be provided in various forms as long as a slit through which the working fluid may pass is formed.

In addition, the amount of working fluid flowing into the pilot chamber 146a may be adjusted by adjusting the cross-sectional area and number of slits.

The pilot disk 143 may be coupled to the auxiliary piston rod 122 and disposed in close contact with an upper portion of the guide disk 144 and cover the upper portion of the guide disk 144 to prevent inflow of working fluid from the upper portion of the guide disk 144 to the pilot chamber 146a.

In addition, the pilot disk 143 may be elastically deformed to prevent a continuous increase in pressure in the pilot chamber 146a.

For example, the pilot disk 143 is elastically deformed to allow the working fluid to pass therethrough according to an increase in pressure of the pilot chamber 146a during the tension stroke.

The pilot disk 143 may be provided in at least one disk type.

The pilot disk 143 includes a disk-S 143b in close contact with the upper portion of the guide disk 144 and adjusting a flow rate of working fluid flowing out of the pilot chamber 146a and an auxiliary disk 143a in close contact with the upper portion of the disk-S 143b to elastically support the disk-S 143b.

The disk-S 143b has a flow groove formed at a position corresponding to a first flow hole H1 of the upper pilot valve 145 and a second flow hole 144a of the guide disk 144.

The auxiliary disk 143a may be provided as a disk having the same size as disk-S 143b and impede flow of the working fluid passing through the flow groove formed in the disk-S 143b, and pressure of the pilot chamber 146a increases, the auxiliary disk 143a may be elastically deformed to allow outflow of the working fluid.

In addition, the valve assembly 140 may further include at least one main disk 149 interposed between the lower pilot valve 148 and the main retainer 151.

This main disk 149 is installed to adjust an elastic deformation coefficient of the lower pilot valve 148, and the number of disks may be increased or decreased according to the needs of a designer and driver.

The frequency-sensitive shock absorber is firmly assembled by certain components so that the piston valve and valve assembly move together with the piston rod to implement damping force generating performance.

That is, the valve assembly 140 is mounted below a lower washer 141 with a spacer 142 in between, and a nut 152 is mounted below the valve assembly 140 and fastened to the auxiliary piston rod 122.

Accordingly, the piston valve and valve assembly mounted on the piston rod may be maintained in a state of being closely coupled in an axial direction of the piston rod and move together with the piston rod.

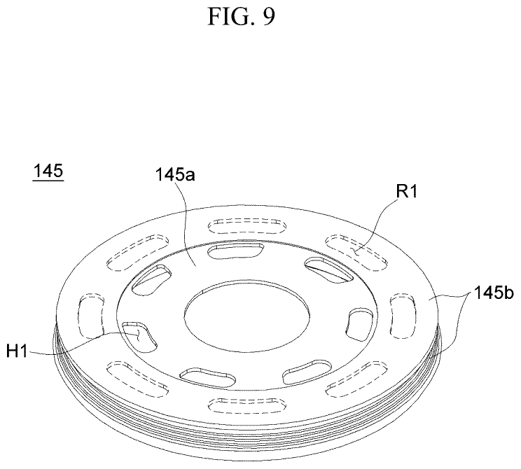

FIG. 8 is an enlarged view of an upper pilot valve in the valve assembly of FIG. 6, FIG. 9 is a view illustrating that the upper valve portion is integrally molded with an upper base portion of the upper pilot valve shown in FIG. 8, and FIG. 10 is a view illustrating the upper base portion of the upper pilot valve shown in FIG. 8.

The upper pilot valve 145 may be coupled to the auxiliary piston rod 122 and may be disposed on top of the pilot chamber 146a.

In addition, the upper pilot valve 146 may be provided to be elastically deformable according to a change in pressure in the pilot chamber 146a.

More specifically, the upper pilot valve 145 includes an upper base portion 145a having an upper surface in close contact with a lower portion of the guide disk 144 and an upper valve portion 145b downwardly protruding along an outer edge of the upper base portion 145a to be in close contact with an inner circumferential surface of the housing 146 to form the pilot chamber 146a.

The upper base portion 145a may be formed of a metal disc shape, and the upper valve portion 145b may be formed of a rubber material or a synthetic resin material to be elastically deformable.

In addition, a plurality of first flow holes H1 may be formed in a penetrating manner radially in the upper base portion 145a and allow the working fluid of the pilot chamber 146a to pass therethrough when the pressure of the pilot chamber 146a continues to increase, thereby preventing an excessive increase in pressure.

In addition, the upper base portion 145a is provided with a plurality of first molded holes R1 formed in a penetrating manner outside the first flow hole H1 in a circumferential direction.

At this time, a rubber material or synthetic resin material that protrudes to a lower side of the upper base portion 145a and forms the upper valve portion 145b is molded to pass through the first molded hole R1 to surround up to an upper edge portion (an outer portion of the first flow hole H1) of the upper base portion 145a.

Accordingly, the upper valve portion 145b may be prevented from peeling off from the upper base portion 145a in a high-pressure and high-temperature environment.

Furthermore, the upper valve portion 145b may be elastically deformed depending on the pressure depending on the amount of working fluid flowing into the pilot chamber 146a. For example, the upper valve portion 145b may be elastically deformed vertically.

The upper pilot valve 145 may expand the volume of the pilot chamber 146a as the working fluid flows into the pilot chamber 146a during a high-frequency stroke, and accordingly, a pressure drop occurs in the pilot chamber 146a momentarily to increase a pressure difference with the main chamber formed in the main retainer 151, which may further promote elastic deformation of the lower pilot valve 148 or opening of the main chamber.

FIG. 11 is a diagram illustrating a guide disk disposed between the pilot disk shown in FIG. 6 and the upper pilot valve.

The guide disk 144 is formed of metal in the form of a disk.

In this guide disk 144, a plurality of second flow holes 144a are formed radially.

At this time, the second flow holes 144a may be formed at positions and the number corresponding to the first flow holes H1 formed in the upper base portion 145a of the upper pilot valve 145.

As described above, in the case in which the rubber material or synthetic resin material that protrudes to the lower side of the upper base portion 145a and forms the upper valve portion 145b is molded to pass through the first molded hole R1 to surround up to the upper edge portion (the outer portion of the first flow hole) of the upper base portion 145a, if the guide disk 144 is not present, the flow groove of the disk-S 143b may be blocked due to the molded rubber material or synthetic resin material or the area of the flow path may not be maintained to be constant, and thus, the target damping force performance cannot be obtained.

Therefore, the guide disk 144 is added to the upper side of the upper base portion 145a so that the disk-S 143b and the guide disk 144 maintain metal-to-metal contact to maintain the area of the flow groove of the disk-S 143b constant, thereby achieving constant target the target damping force performance.

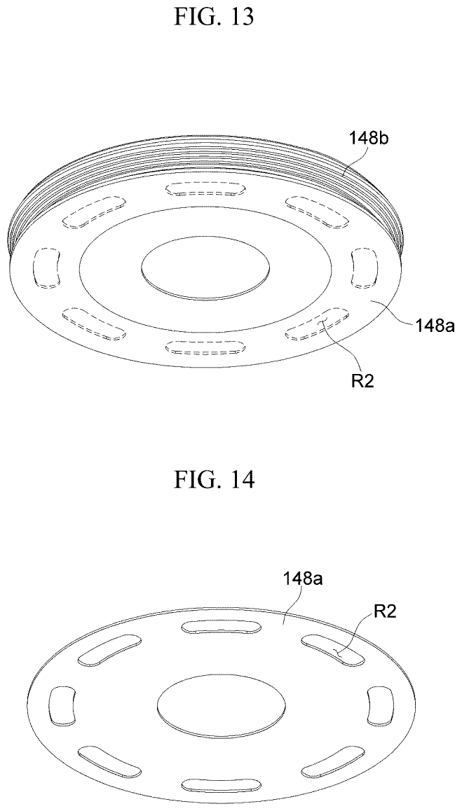

FIG. 12 is an enlarged view of a lower pilot valve in the valve assembly of FIG. 6, FIG. 13 is a view illustrating that a lower valve portion is integrally molded with a lower base portion of the lower pilot valve shown in FIG. 12, and FIG. 14 is a view illustrating the lower base portion of the lower pilot valve shown in FIG. 12.

The lower pilot valve 148 is interposed between the housing 146 and the main retainer 151, and the upper and lower portions thereof may be in close contact with the housing 146 and the main retainer 151, respectively, thereby partitioning and forming the pilot chamber 146a and the main chamber.

In addition, the lower pilot valve 148 may be provided to be elastically deformable due to a difference in pressure between the pilot chamber 146a and the main chamber.

More specifically, the lower pilot valve 148 includes a lower base portion 148a having a bottom surface in close contact with an upper portion of the main retainer 151 and a lower valve portion 148b protruding upwardly along an outer edge of the lower base portion 148a and in close contact with an inner circumferential surface of the housing 146 to form the pilot camber 146a.

The lower base portion 148a may be formed of a metal disc shape, and the lower valve portion 148b may be formed of a rubber or synthetic resin material to be elastically deformable.

Accordingly, the lower valve portion 148b may be elastically deformed according to a difference in pressure depending on the amount of working fluid flowing into the main chamber and the pilot chamber 146a. For example, the lower valve portion 148b may be elastically deformed upwardly.

In addition, a plurality of second molded holes R2 are formed in a penetrating manner radially in the lower base portion 148a.

At this time, a rubber material or synthetic resin material that protrudes to an upper side of the lower base portion 148a and forms the lower valve portion 148b is molded to pass through the second molded hole R2 to surround up to a lower edge portion of the lower base portion 148a.

Accordingly, the lower valve portion 148b may be prevented from peeling off from the lower base portion 148a in a high-pressure and high-temperature environment.

The lower pilot valve 148 is in contact with an upper portion of the main retainer 151 during a low-frequency stroke.

For example, during the low-frequency stroke, the lower pilot valve 148 remains in contact with an upper end of the main retainer 151 due to pressure balance between the pilot chamber 146a and the main chamber.

In addition, during a high-frequency stroke, the lower pilot valve 148 may be spaced apart from the upper portion of the main retainer 151 to open the main chamber as the pressure of the main chamber increases more than the pressure of the pilot chamber 146a.

The present disclosure described above is not limited to the aforementioned embodiments and the accompanying drawings, and it is obvious for those skilled art that various substitutions, modifications, and changes may be made without departing from the scope of the present disclosure.

What is claimed is:

1. A valve assembly employed in a shock absorber, the valve assembly comprising:
a housing provided in a shape of a ring through which a piston rod that reciprocates inside a cylinder passes through a center, in which hollows are provided in the upper and lower surfaces in a communicatable manner to form a pilot chamber;
a main retainer coupled to the piston rod and disposed in a lower portion of the housing, an upper portion of which is opened to form a main chamber;
a lower pilot valve coupled to the piston rod to be interposed between the housing and the main retainer so that upper and lower portions thereof are in close contact with the housing and the main retainer, respectively, to divide and simultaneously form the pilot chamber and the main chamber; and
an upper pilot valve coupled to the piston rod and disposed on top of the pilot chamber and provided to be elastically deformable according to a change in pressure of the pilot chamber,
wherein the upper pilot valve and the lower pilot valve each includes a base portion in the form of a metal plate and a valve portion integrally molded with the base portion as an elastic material passes through a molded hole formed in a penetrating manner in the base portion, and elastically deformed vertically.

2. The valve assembly of claim 1, wherein the upper pilot valve includes an upper base portion having a piston rod coupled to a center, formed in the shape of a metal disk, has a plurality of first flow holes formed in a penetrating manner radially, and has a plurality of first molded holes formed in a penetrating manner in a circumferential direction outside the first flow holes.

3. The valve assembly of claim 2, wherein the upper pilot valve includes an upper valve portion in which an elastic material passes through the first molded hole, surrounds an outer portion of the first flow hole, which is an upper edge of the upper base portion, and protrudes to a lower side of the upper base portion.

4. The valve assembly of claim 3, wherein the elastic material is a rubber material or an elastic synthetic resin material.

5. The valve assembly of claim 1, wherein the lower pilot valve has a piston rod coupled to a center, is formed of a metal disc shape, and has a plurality of second molded holes formed in a penetrating manner radially.

6. The valve assembly of claim 5, wherein the lower pilot valve includes a lower valve portion in which an elastic material passes through the second molded hole, surrounds a lower edge of the lower base portion, and protrudes to an upper side of the lower base portion.

7. The valve assembly of claim 3, wherein the valve assembly further includes a guide disk formed of metal coupled to the piston rod to be located above the upper base portion.

8. The valve assembly of claim 7, wherein a plurality of second flow holes are formed in a penetrating manner radially in the guide disk.

9. The valve assembly of claim 8, wherein the second flow holes are formed in a number and positions corresponding to the first flow holes formed in the upper base of the upper pilot valve.

10. The valve assembly of claim 8, wherein the guide disk is maintained to be in metal-to-metal contact with a pilot disk located in an upper portion thereof and elastically deformed to allow working fluid to pass therethrough according to an increase in pressure of the pilot chamber during a tension stroke.

11. The valve assembly of claim 10, wherein the pilot disk includes a disk-S in close contact with the upper portion of the guide disk and adjusting a flow rate of the working fluid flowing out of the pilot chamber and an auxiliary disk in close contact with an upper portion of the disk-S to elastically support the disk-S.

12. The valve assembly of claim 11, wherein the disk-S has a predetermined flow groove formed at a position corresponding to a first flow hole of the upper pilot valve and a second flow hole of the guide disk.

13. The valve assembly of claim 12, wherein the auxiliary disk is provided as a disk having the same size as the disk-S, impedes flow of working fluid passing through the flow groove, and is elastically deformed to allow working fluid to flow out when pressure of the pilot chamber increases.

14. A frequency-sensitive shock absorber including a piston rod that reciprocates inside a cylinder filled with working fluid, a piston valve mounted on the piston rod and reciprocating inside the cylinder in compression and tension stroke directions to generate damping force based on resistance of the working fluid, and a valve assembly mounted on the piston rod to be disposed below the piston valve and generating damping force that changes depending on a frequency during the tension stroke,
wherein the valve assembly comprises:
a housing provided in a shape of a ring through which a piston rod that reciprocates inside a cylinder passes through a center, in which hollows are provided in the upper and lower surfaces in a communicatable manner to form a pilot chamber;
a main retainer coupled to the piston rod and disposed in a lower portion of the housing, an upper portion of which is opened to form a main chamber;
a lower pilot valve coupled to the piston rod to be interposed between the housing and the main retainer so that upper and lower portions thereof are in close contact with the housing and the main retainer, respectively, to divide and simultaneously form the pilot chamber and the main chamber; and
an upper pilot valve coupled to the piston rod and disposed on top of the pilot chamber and provided to be elastically deformable according to a change in pressure of the pilot chamber, wherein the upper pilot valve and the lower pilot valve each includes a base portion in the form of a metal plate and a valve portion integrally molded with the base portion as an elastic material passes through a molded hole formed in a penetrating manner in the base portion, and elastically deformed vertically.

15. The frequency-sensitive shock absorber of claim 14, wherein
the valve assembly further includes a disc-shaped metal guide disk coupled to the piston rod to be located above the upper pilot valve, and
the guide disk is maintained to be in metal-to-metal contact with a pilot disk located in an upper portion thereof and elastically deformed to allow working fluid to pass therethrough according to an increase in pressure of the pilot chamber during a tension stroke.
